(19) United States
(12) Patent Application Publication
(10) Pub. No.: US 2013/0044131 A1
(43) Pub. Date: Feb. 21, 2013

(54) SOFTWARE CONTROLLER FOR AUDIO MIXER EQUIPMENT

(71) Applicant: Moheb MILAD, Dubai (AE)

(72) Inventor: Moheb MILAD, Dubai (AE)

(21) Appl. No.: 13/528,992

(22) Filed: Jun. 21, 2012

(30) Foreign Application Priority Data
Aug. 15, 2011 (GB) 1114008.4

(51) Int. Cl. G09G 5/00

(52) U.S. Cl. 345/633

(57) ABSTRACT

A method for revealing changes in settings of an analogue control console, the method comprising:
receiving a captured image of the analogue control console;
creating a composite image by superimposing the captured image and a live image of the analogue control console; and
displaying the composite image.

### FIELD

This invention relates generally to analogue control console settings.

### BACKGROUND

Sound mixing is the final process in music/sound production. The ‘mix’ determines how the recording will sound to the listener. It is well known that musicians, producers and sound recording/mixing engineers tend to make several mixes or change their mind regarding the final mix of a song or piece of music. Additionally, a DJ (disk jockey) may wish to apply certain settings to a recording when playing that recording. Mixing desks are also used during the recording of sound and during amplified live performances.

Digital mixers and computer based mixing software have become very popular during the last 20 years or so due to their ability to easily save and recall many different mix settings. However digital mixers are many times more expensive than analogue mixers having equivalent functions. Analogue mixers are generally easier to operate and are more reliable. It is also the opinion of many musicians and producers that the sound quality of analogue mixing systems is better than their digital counterparts. Analogue mixers therefore still enjoy widespread use, especially where purchase cost is a factor; however their usefulness is limited by their inability to save individual mix settings.

### SUMMARY

The invention is defined by the claims.

### BRIEF DESCRIPTION OF THE DRAWINGS

Embodiments of the invention will now be described, by way of example only, with reference to the accompanying drawings, in which:

FIG. 1 is a block diagram of a system for revealing changes in settings of an analogue control console in accordance with aspects of the present invention;

FIG. 2 is an image showing a camera positioned over an analogue audio mixer, as used with aspects of the present invention;

FIG. 3 is an image of an analogue audio mixer captured by the camera, as provided by aspects of the present invention;

FIG. 4 shows a composite image formed by superimposing a live image of the analogue audio mixer received from the camera onto the captured image of FIG. 3, as provided by aspects of the present invention;

FIG. 5 shows a portion of the image of FIG. 4 in which knobs that show a change in position are circled, to ease explanation of aspects of the present invention; and

FIG. 6 is a flow chart illustrating a method for revealing changes in settings of an analogue control console in accordance with aspects of the present invention.

### DETAILED DESCRIPTION OF EMBODIMENTS

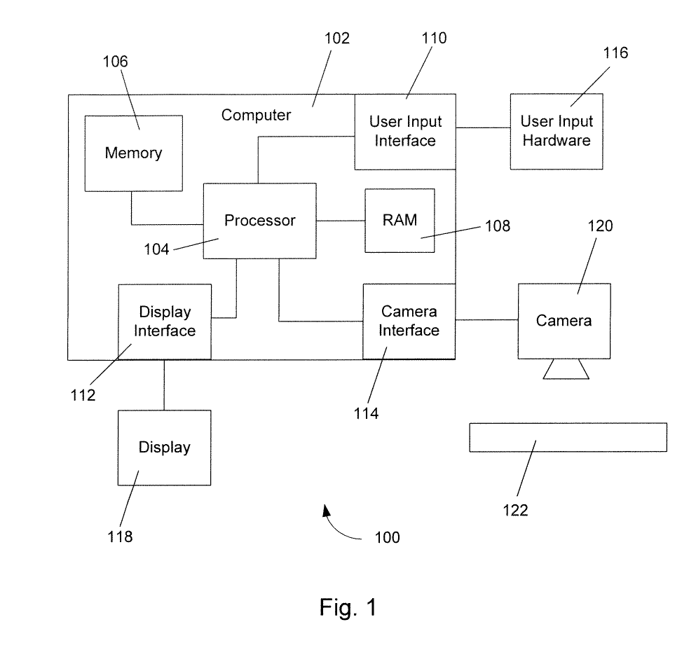

Referring firstly to FIG. 1, a block diagram of a system 100 for revealing changes in settings of an analogue control console is shown. The system comprises computing apparatus 102, also referred to herein as a computer 102. The computer 102 has a processor 104 which is connected to and communicates with a memory 106, RAM 108, a user input interface 110, a display interface 112 and a camera interface 114. The user input interface 110 is configured to connect with user input hardware 116. The display interface 112 is configured to connect with a display 118. The camera interface is configured to connect with a camera 120. The system also comprises an analogue control console 122, which may also be referred to in this specification as “a console”, “a mixer”, “an analogue audio mixer”, “audio mixer” or “a mixing desk”. When the system 100 is in use, the camera 120 is directed at the console 122.

The computer 102 may be a laptop, netbook, tablet or desktop computer, for instance. It may run an operating system such as Mac OSX, Windows 7, or a Linux operating system such as Ubuntu.

The processor 104 may be an integrated circuit of any kind or a collection of integrated circuits. The processor 104 may access RAM 108 in order to process data and may control the storage of data in memory 106. Memory 106 may be a non-volatile memory of any kind such as a Read Only Memory (ROM), a flash memory and a magnetic drive memory. The RAM 108 may be volatile memory and may be of any type, for example Static RAM (SRAM), Dynamic RAM (DRAM) or Flash memory. The processor 104 operates under control of an operating system stored in the memory 106. The operating system may comprise code relating to hardware such as the user input interface 110, display interface 112 and camera interface 114, as well as the basic operation of the computer 102. The processor 104 is connected to and controls operation of the other components of the computer 102.

The memory 106 may also store one or more software programs relating to operation of the camera. This software may be installed on the computer 102 by a user or may be preloaded onto the computer 102. The software may be specific to the make and model of the camera 122 or the software may be generic and suitable for use with any camera 120 connected via the camera interface 114. The software may be configured to control operation of the camera 120, for example by issuing commands to capture still images or relay live images in response to user inputs. The software may be configured to cause image data to be received from the camera 120 and (in conjunction with the processor 104) to cause the received image data to be displayed on a display 118. The software may also be configured to modify images by causing multiple saved or live images to be overlaid and by applying a transparency effect to one or more saved or live images and to cause display of the modified images. The software program may be configured to provide a graphical user interface.

The user input hardware 116 may take any suitable form, for example any combination of a keyboard, mouse, tablet, trackball or microphone. The user input hardware 116 may also comprise a touch screen, in which case the user input hardware 116 may be integral with the display 118. The display 118 may be integrated with the computer 102, such as with a laptop or tablet computer, or may be a separate device connected to the computer 102 via the display interface 112. The display interface 112 may take any suitable form, for example VGA, DVI, SCART, S-Video, RCA or Display Port connections. The user input interface 110 may take any suitable form such as PS/2 or USB.

Although only one display interface 112 and one user input interface 116 are shown, the computer 102 may have more than one of each of these interfaces and the computer 102 may have several different connection types of each of these interfaces.

The camera 120 may comprise any image sensing device such as a charge-coupled device (CCD) or an active pixel sensor such as a complementary metal oxide semiconductor (CMOS) device. In some embodiments, the camera 120 may be a commercially available Webcam. The camera interface 114 may be any suitable connection such as USB. Alternatively any or all of the display interface 112, user input interface 116 and camera interface 114 may connect wirelessly with the computer 102, via any suitable protocol such as IEEE 802.11 (Wifi), Bluetooth or Wireless USB.

The control console 122 may take one of several forms. In some embodiments, the console 122 is an analogue audio mixer, often referred to as a mixing desk. Audio mixers are used to adjust the volume and equalisation in sound recordings, particularly those having several audio channels. Audio mixers may also be used to adjust the levels in a live performance. Analogue audio mixers generally have a number of knobs and faders (generally referred to as adjusters or controls) which are adjusted manually by a user of the audio mixer.

In some other embodiments, the console 122 is a lighting desk. The lighting desk may control the intensity and/or direction of lights in a performance venue, for example. The lighting desk may comprise a number of manually adjusted knobs and sliders. The control console 122 is however not limited to the control of light or sound output/input and embodiments may include any analogue control console 122 requiring the manual adjustment of knobs, sliders and the like to achieve different settings of the console 122.

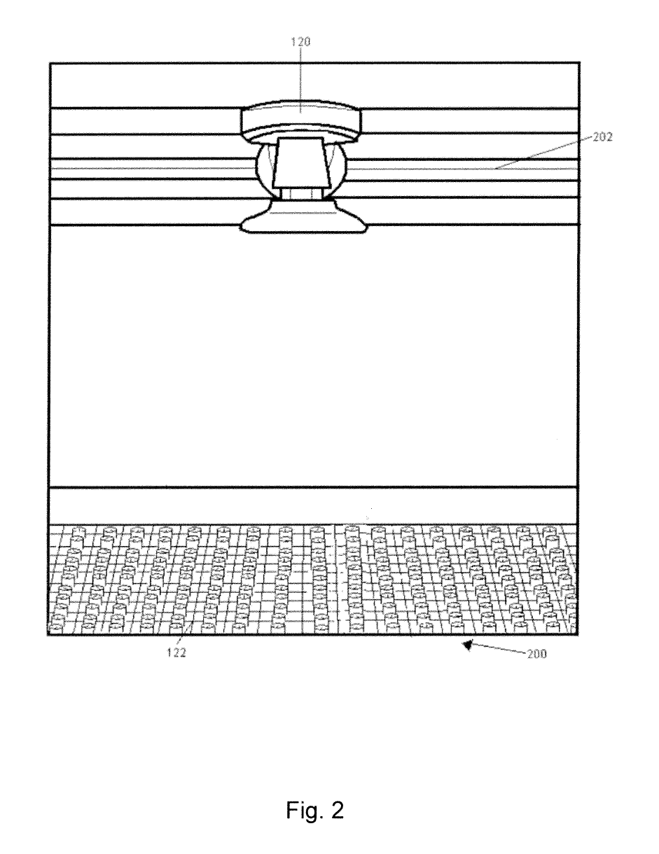

In the embodiments depicted in FIGS. 2 to 5, the control console 122 is an analogue audio mixer 122. Referring now to FIG. 2, an image 200 of a part of the system 100 comprising the camera 120 and the audio mixer 122 is shown. The camera 120 is shown suspended above the audio mixer 122. The camera 120 is directed at the mixer 122. The camera 120 is a webcam capable of capturing still images and live images. A rig 202 may be provided for mounting the camera 120 such that the camera 120 is positioned at a suitable distance from the mixer 122. This may ensure that the entire mixer 122 is within the field of view of the camera 120. The camera 120 may be positioned over the approximate centre of the mixer 122. The rig 202 may also ensure that the camera 120 is in the same position relative to the mixer 122 for each image capture or live image relay. Alternatively, the camera 120 may be affixed, permanently or temporarily, to a wall or other vertical surface behind or to one side of the mixer 122.

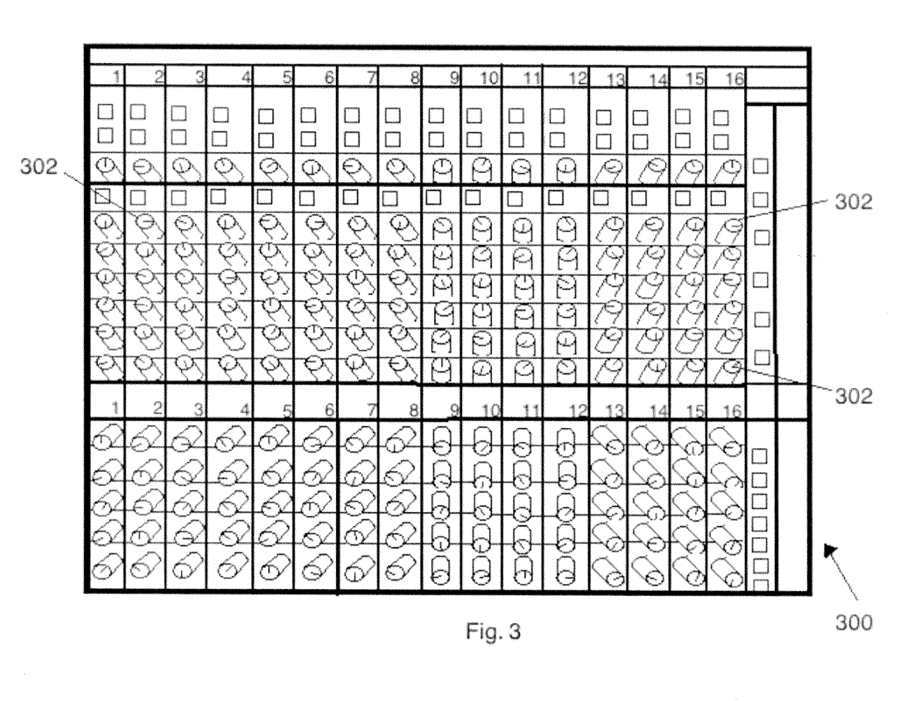

FIG. 3 shows an image 300 of a typical analogue audio mixer 122 which has been captured by the camera 120. The image 300 may be a colour image. The mixer 122 shown has 16 channels, however the number of channels which the mixer 122 may control is merely an example. Each channel has a number of corresponding knobs 302 which may control, for instance, the input signal gain, the master output volume, the output or input volumes of various frequency ranges (equalisation controls), the clipping or shaping of the audio signal or the degree of an audio effect applied to the signal. This is not an exhaustive list and mixers are known which have many more functions. The mixer 122 may alternatively or in addition comprise a number of sliders for controlling the same or other sound properties. The particular functions present are merely examples and the apparatus may be suitable for use with any analogue audio mixer 122.

The positions of the knobs 302 and/or sliders of the mixer 122 define a particular mix setting. During sound recording or an amplified live performance, the positions of the knobs 302 and/or sliders determine directly how the performance will sound.

A user of the system 100 may cause the image 300 of the audio mixer 122 to be captured by operating a switch or button on the camera 120 itself, or by interacting with the software program stored in the memory 106 of the computer 102 via user input hardware 116. For example, a user may operate user input hardware 110 such as a mouse or keyboard to open and run the software application such that live or periodically updated images are received from the camera 120 and displayed on the display 118. The user may then cause an image of the mixer 122 to be captured by selecting an appropriate icon within the software program's graphical user interface. The captured image may be automatically saved in the memory 106 of the computer 102. Alternatively, the user may be prompted to specify a file name and location for the captured image prior or subsequent to image capture.

Capturing an image 300 of the audio mixer 122 allows the user to quickly and easily make a visual record of that particular mix setting. At some later time, the user may wish to recall that mix setting and apply it to the same or another sound recording or performance. To this end, the software program may be configured to overlay a live or periodically updated image of the analogue audio mixer 122 over the captured image 300 of the mixer 122. The software may apply a transparency effect to both of these images such that both images are visible after the overlay and any differences between the images are discernable by eye. In the context of the invention, the term “live image” should be understood to mean any image representing the recent appearance of the console 122. For example, although some cameras 120 suitable for use with the invention may capture several images per second, giving the impression of a video feed, some other cameras 120 may capture only one image per second or one image every few seconds. These periodic images may represent a “live image” of the console 122, however a camera 120 which captures at least one image per second in live image mode is preferable.

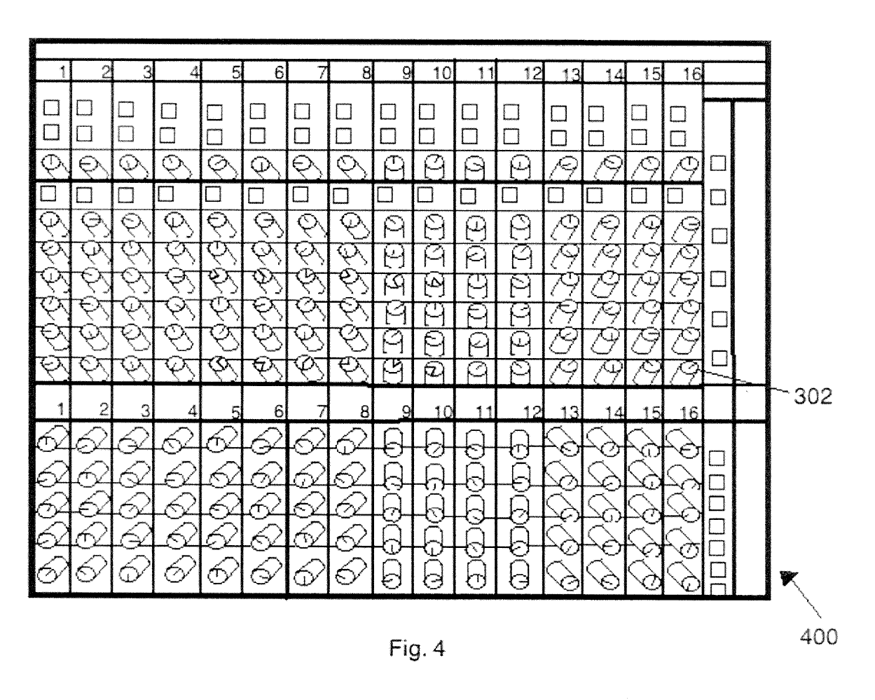

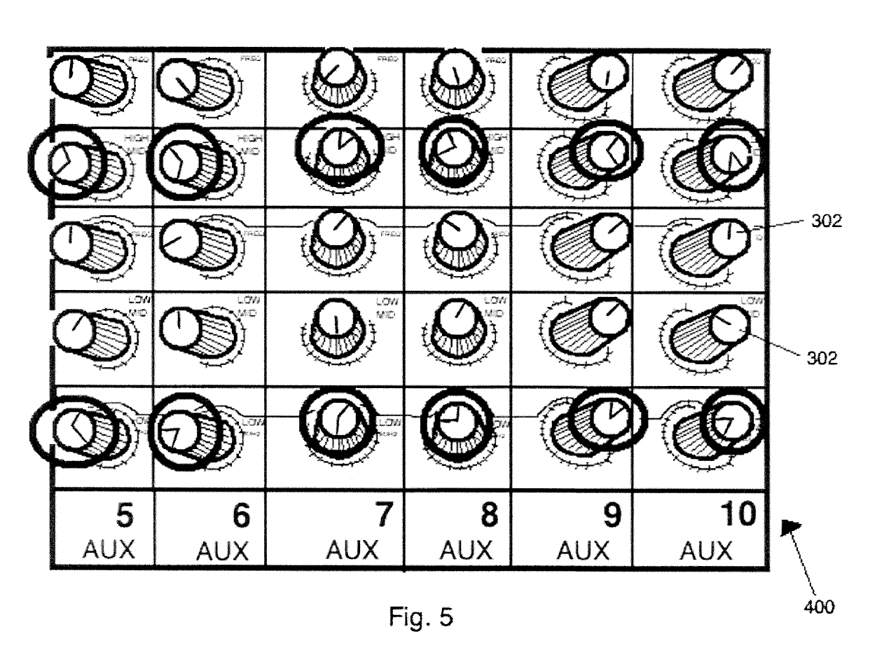

FIGS. 4 and 5 show a composite image 400 formed by the overlay of the live and captured images of the mixer 122 with a transparency effect applied to each image. FIG. 4 shows the entire composite image 400 which is produced. This image may be displayed on the display 118. FIG. 5 shows a portion of the composite image 400 where differences have been highlighted by circles around those knobs 302 having a different rotational position. It will be appreciated that these circles may not be displayed, and are provided to allow the reader to better understand the effects of the operation of the apparatus.

The composite image 400 may be displayed in a graphical user interface window of the software program. The application of the transparency effect and the display of the composite image may be performed in response to user selection of an icon on the graphical user interface. This icon may be any suitable graphic, for example two overlapping rectangles and may have a tag reading “overlay” or “overlay saved image” for instance. The software program may be configured to cause the image 400 to be maximised to fill the whole of display 118 and/or to allow the user to zoom in to view a portion of the composite image 400 in greater detail.

The overlaying process may require that the camera 120 is in the same position relative to the mixer 122 when relaying the live images as it was when the still image 300 was captured. If the position of the camera 120 is adjustable, for example if the camera may slide along the supporting rig 202, the user may adjust the position of the camera 120 until the images are aligned. The user may judge the alignment by observing the composite image on the display 118. Alternatively, if the captured image 300 and live image are misaligned, the software program may be configured to align the images automatically. For example, the software program may be configured to detect edges of the mixer 122 and to reposition and resize the captured image 300 to match the live image. Whether the alignment of the captured and live images is performed manually or automatically, the analogue audio mixer 122 in question should be the same make and model such that the knobs 302 are in the same locations on the mixer 122 and represent the same audio property.

The transparency effect applied to the images may be of any degree suitable to allow differences between the images to be discerned by eye when the images are overlaid. In particular, differences between the rotational positions of the knobs 302 are discernable. The transparency applied to each image may be 50%, however a range of transparencies may be suitable, for example 40-60%. The transparencies of each of the images may not be the same.

Alternatively or in addition, differences between the live and captured images may be detected automatically by the software program either before or after the overlay has occurred. The software program may be configured to highlight the differences on the composite image 400 when the image 400 is displayed.

While the composite image 400 is being displayed, the user may manually adjust a knob 302 until no difference in the composite image 400 can be seen. At this point, the knob 302 is in the same position as it was when the saved image 300 was captured. By performing this step for each of the adjusters (knobs, sliders or others) which show a difference in position, the mix settings represented in the captured image 300 can be recalled.

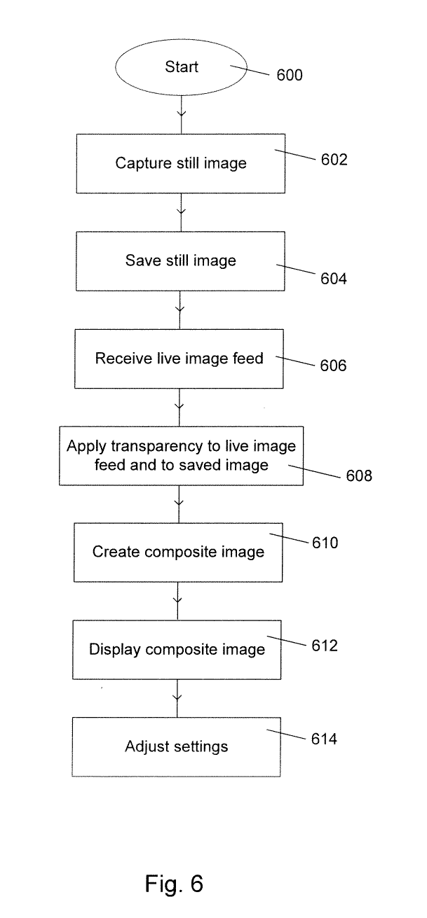

A method for revealing changes in settings of the analogue control console 122 will now be described with reference to the flow chart of FIG. 6. The method begins at step 600. At this stage the computer 102 and camera 120 have been powered on and the camera 120 is positioned such that it is directed at the analogue audio mixer 122, as shown in FIG. 2.

At step 602 an image 300 of the mixer 122 is captured by the camera 120. A typical image 100 of an audio mixer 122 is shown in FIG. 3. This step may be performed in response to a user command which is interpreted by the software program running on the computer 102 and which controls operation of the camera 120. The user command may be received via a graphical user interface of the software program or via a hardware button on the camera 120 itself. At step 604, the image data representing the captured image 300 is saved in the memory 106 of the computer 102. Alternatively, or in addition, the image data may be saved remotely, for example on a remote server accessed via the internet. Before the image 300 is saved at step 604, the user may be prompted via the graphical user interface of the software program to specify a file name and/or location for the image 300.

At some later time, a live image of the mixer 122 is received via the camera 120 at step 606. The live image may be a periodically updated image as described above. This step may also be performed in response to a user command which is interpreted by the software program. The user command may be received via a graphical user interface of the software program or via a hardware button on the camera 120 itself.

At step 608 a transparency effect is applied to both the live image and the saved image 300. As previously mentioned, the degree of transparency applied to each image may not be equal. The software program may allow a user to adjust the degree of the transparency effect applied to each image.

At step 610, a composite image 400 consisting of an overlay of the live and saved images, each with a transparency effect applied, is created. At step 612, the composite image 400 is displayed on a display screen 118. Step 612 may occur automatically and immediately after the creation of the composite image 400 in step 610. An exemplary composite image of an audio mixer 122 is shown in FIGS. 4 and 5. As the composite image 400 is comprised of a still image and a live image, the composite image 400 is a live image which is continuously updated as the live image is updated. Thus the composite image 400 could be described as a “composite image feed” or “live composite image”. In some embodiments, the software program may be configured to adjust the composite image 400 such that the contrast is optimised, allowing differences between the images to be more easily discerned. This adjustment may be automatic or manual and may involve adjusting brightness, colour, hue and the degree of transparency applied to either image.

At step 614, a user of the audio mixer 122 adjusts the settings of the mixer 122 by moving the individual adjusters (knobs 302, sliders, faders etc.) where a difference in position is visible. As the composite image 400 is being displayed on a display, any changes are observable in real time on the display 118. Thus, a user is able to adjust the settings of the mixer 122 while observing the effects directly on the display 118. This allows a user to make quick and accurate adjustments.

The user may continue to adjust the settings of the mixer 122 until no differences can be seen in the composite image 400. At this point, the earlier mix represented by the saved image 300 has been recalled. However, the user is not limited to returning the mixer 122 exactly to a previous setting and may only wish to recall some of the previous settings. For example, the user may wish to return channels 1-8 to an earlier setting, but apply new settings to channels 9-16. The present invention does not impose a settings change on the mixer 122, but reveals differences such that a user can easily make the desired changes.

The system described above provides a relatively quick method for recalling settings on an analogue control console 122. Current camera technology allows high resolution images to be captured such that any differences in adjuster positions can be easily discerned by observation by a user of the console 122. The system is also relatively inexpensive to implement. Additionally, it can be retrofitted to virtually any existing analogue console 122.

It will be appreciated that the above described embodiments are purely illustrative and are not limiting on the scope of the invention. Other variations and modifications will be apparent to persons skilled in the art upon reading the present application. Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

What is claimed is:

1. A method comprising:
receiving a captured image of an analogue control console;
creating a composite image by superimposing the captured image and a live image of the analogue control console; and
displaying the composite image to reveal changes in settings of the analogue control console.

2. A method according to claim 1, the method further comprising capturing the captured image of the analogue control console.

3. A method according to claim 1, wherein superimposing comprises applying a transparency of between 40% and 60% to each of the captured image and the live image and overlaying the partially transparent images.

4. A method according to claim 3, wherein the superimposing comprises applying a transparency of between 45% and 55% to each of the captured image and the live image and overlaying the partially transparent images.

5. A method according to claim 1, wherein the analogue control console comprises a plurality of adjusters and the settings of the analogue control console comprise the positions of the plurality of adjusters.

6. A method according to claim 5, wherein the adjusters control the volume or equalisation of one or more channels of the analogue audio mixer.

7. A method according to claim 5, wherein the adjusters are one or more of knobs, faders, buttons and switches.

8. A method according to claim 6, wherein the adjusters are one or more of knobs, faders, buttons and switches.

9. A method according to claim 1, where in the analogue control console is an analogue audio mixer.

10. An apparatus comprising:
at least one processor; and
at least one memory including computer program code,
wherein the at least one memory and the computer program code are configured, with the at least one processor, to cause the apparatus to perform a method comprising:
receiving a captured image of an analogue control console;
creating a composite image by superimposing the captured image and a live image of the analogue control console; and
displaying the composite image to reveal changes in settings of the analogue control console.

11. An apparatus according to claim 10, wherein the memory is configured to store captured images of the analogue control console for subsequent retrieval.

12. A system comprising the apparatus of claim 10 and an image capture device configured to capture an image of the analogue control console.

13. A system comprising the apparatus of claim 10 and the analogue control console.

14. A system according to claim 13, wherein the analogue control console comprises a plurality of adjusters and the settings of the analogue control console comprise the positions of the plurality of adjusters.

15. A system according to claim 14, wherein the adjusters are configured to control the volume or equalisation of one or more channels of the analogue audio mixer.

16. A system according to claim 14, wherein the adjusters are one or more of knobs, faders, buttons and switches.

17. A system according to claim 13, wherein the analogue control console is an analogue audio mixer.

18. A non-transitory computer-readable storage medium having stored thereon computer-readable code, which, when executed by computing apparatus, causes the computing apparatus to perform a method comprising:
receiving a captured image of the analogue control console;
creating a composite image by superimposing the captured image and a live image of the analogue control console; and
displaying the composite image.

19. A medium according to claim 18, further comprising code which when executed causes the computing apparatus to perform capturing the captured image of the analogue control console.

20. A medium according to claim 18, further comprising code which when executed causes the computing apparatus to perform superimposing by applying a transparency of between 40% and 60% to each of the captured image and the live image and overlaying the partially transparent images.
